(19) United States
(12) Patent Application Publication
(10) Pub. No.: US 2024/0372455 A1
(43) Pub. Date: Nov. 7, 2024

(54) RESIDUAL ERROR CORRECTION IN A 3-LEVEL POWER CONVERTER FEEDBACK LOOP

(71) Applicant: Cirrus Logic International Semiconductor Ltd., Edinburgh (GB)

(72) Inventors: Hasnain AKRAM, Austin, TX (US); Graeme G. MACKAY, Austin, TX (US)

(73) Assignee: Cirrus Logic International Semiconductor Ltd., Edinburgh (GB)

(21) Appl. No.: 18/312,406

(22) Filed: May 4, 2023

(51) Int. Cl. H02M 1/00

(52) U.S. Cl. CPC H02M 1/0025; H02M 1/0009

(57) ABSTRACT

A closed-loop feedback control system may include a first feedback control loop configured to regulate a first physical quantity, a second feedback control loop orthogonal to the first feedback control loop and configured to regulate a second physical quantity, and a correction block configured to apply a correction term to the first feedback control loop based on a parameter of the second feedback control loop.

### FIELD OF DISCLOSURE

The instant disclosure relates generally to processing systems, and more specifically, to correcting residual error in a 3-level power converter feedback loop.

### BACKGROUND

Power converters, including 3-level inductive-based power converters, may be used in many applications, including the regulation of supply voltages for powering electrical and/or electronic circuits in battery-powered systems. Power converters are sometimes also known as “switched mode power supplies.” FIG. 1 illustrates an example architecture for 3-level power converter feedback circuit 100, as is known in the art. As shown in FIG. 1, 3-level power converter feedback circuit 100 may include a 3-level power converter 102 comprising a plurality of switches 104, a flying capacitor 106, a power inductor 108, and an output capacitor 110 arranged as depicted. In operation, 3-level power converter feedback circuit 100 may convert an input voltage V_{IN} (e.g., which may be provided by a battery or other source of electrical energy) into a regulated output voltage V_{OUT} which in turn may be used to supply electrical and/or electronic circuits based on control signals from a pulse-width modulation (PWM) modulator 112 that control switching of switches 104.

PWM modulator 112 may generate control signals as a function of two parameters: a desired duty cycle D for controlling an inductor current I_{L} flowing through power inductor 108 and a balance factor α that defines a desired charge balance across flying capacitor 106 in order to regulate flying voltage V_{FLY}. Duty cycle D may be controlled by a feedback loop based on a measurement of inductor current I_{L}, while balance factor α may be controlled by a feedback loop based on a measurement of flying voltage V_{FLY}.

In the feedback loop for duty cycle D, a feedback filter 114 may apply a filter response (e.g., a moving average filter) to the measurement of inductor current I_{L}, and such filtered current may be subtracted from a setpoint target current I_{TGT} to generate an inductor error signal. The setpoint target current I_{TGT} may be a desired peak current, average current, or other suitable current setpoint for inductor current I_{L}. The inductor current error signal may be filtered by a loop filter 116 that applies a function to convert the inductor error signal into desired duty cycle D.

Similarly, in the feedback loop for balance factor α, a feedback filter 124 may apply a filter response (e.g., a moving average filter) to the measurement of flying voltage V_{FLY}, and such filtered voltage may be subtracted by half of input voltage V_{IN} to generate a flying voltage error signal. Such flying voltage error signal may be filtered by a loop filter 126 that applies a function to convert the flying voltage error signal into balance factor α.

To the first order, balance factor α and desired duty cycle D are sufficiently orthogonal such that both feedback control loops can co-exist without interfering with one another. However, each feedback control loop may include information not present in the other feedback control loop that might be useful to correct residual errors in the other feedback control loop. When the feedback loops are isolated from one another, as is the case in traditional implementations such as that shown in FIG. 1, such information cannot be utilized.

### SUMMARY

In accordance with the teachings of the present disclosure, certain disadvantages and problems associated with existing 3-level power converter architectures may be reduced or eliminated.

In accordance with embodiments of the present disclosure, a closed-loop feedback control system may include a first feedback control loop configured to regulate a first physical quantity, a second feedback control loop orthogonal to the first feedback control loop and configured to regulate a second physical quantity, and a correction block configured to apply a correction term to the first feedback control loop based on a parameter of the second feedback control loop.

In accordance with these and other embodiments of the present disclosure, a method may include regulating a first physical quantity with a first feedback control loop, regulating a second physical quantity with a second feedback control loop orthogonal to the first feedback control loop, and applying a correction term to the first feedback control loop based on a parameter of the second feedback control loop.

In accordance with these and other embodiments of the present disclosure, an integrated circuit may include circuitry implementing a first feedback control loop configured to regulate a first physical quantity, circuity implementing a second feedback control loop orthogonal to the first feedback control loop and configured to regulate a second physical quantity, and circuitry implementing a correction block configured to apply a correction term to the first feedback control loop based on a parameter of the second feedback control loop.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example architecture for a 3-level power converter feedback circuit, as is known in the art;

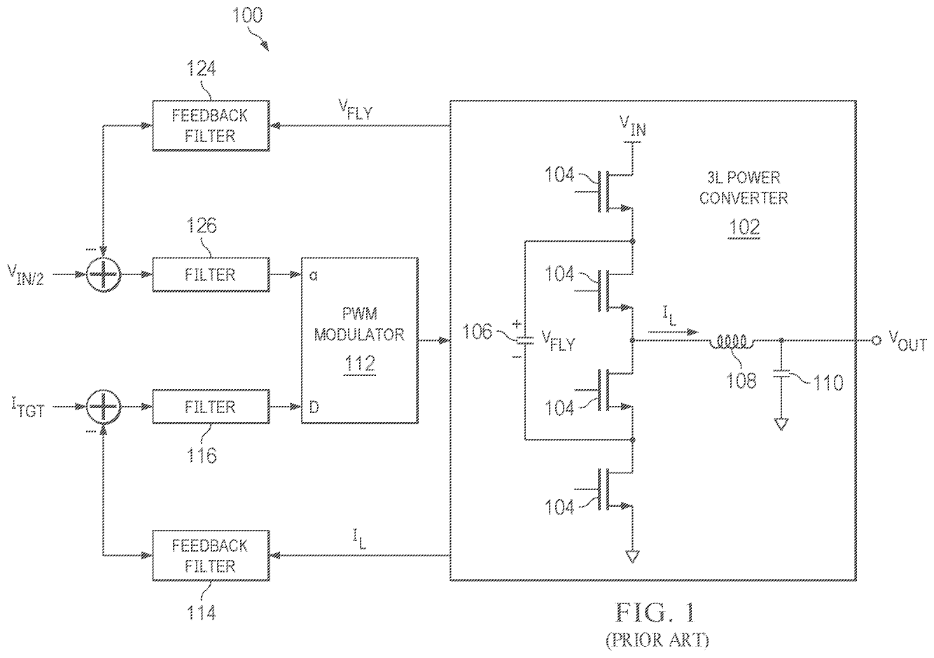

FIG. 2 illustrates a block diagram of selected components of an example architecture for a 3-level power converter feedback circuit, in accordance with embodiments of the present disclosure; and

FIG. 3 illustrates a block diagram of selected components of another example architecture for a 3-level power converter feedback circuit, in accordance with embodiments of the present disclosure.

### DETAILED DESCRIPTION

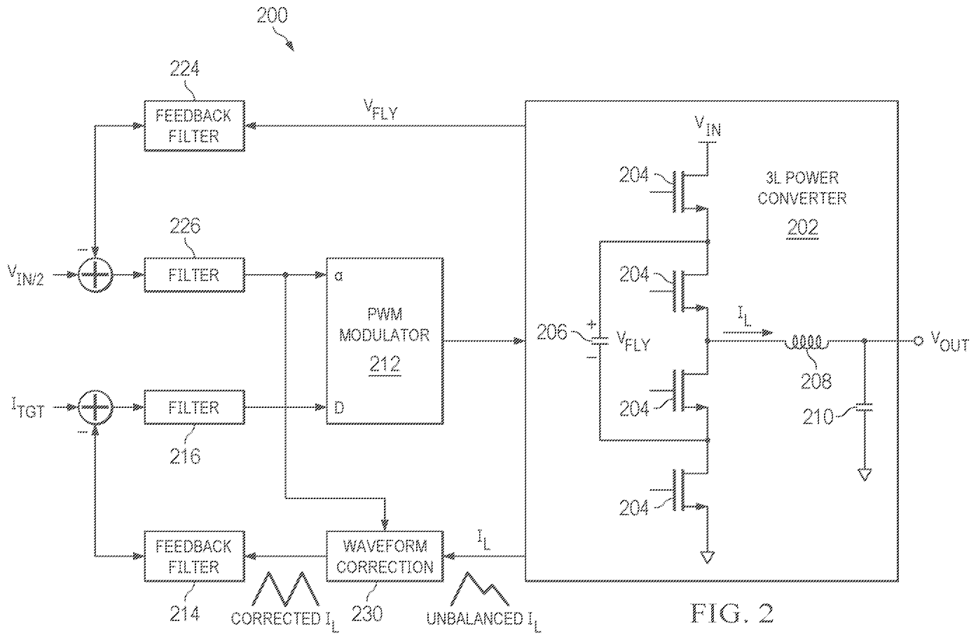

FIG. 2 illustrates a block diagram of selected components of an example architecture for 3-level power converter feedback circuit 200, in accordance with embodiments of the present disclosure. As shown in FIG. 2, 3-level power converter feedback circuit 200 may include a 3-level power converter 202 comprising a plurality of switches 204, a flying capacitor 206, a power inductor 208, and an output capacitor 210 arranged as depicted. In operation, 3-level power converter feedback circuit 200 may convert an input voltage V_{IN} (e.g., which may be provided by a battery or other source of electrical energy) into a regulated output voltage V_{OUT} which in turn may be used to supply electrical and/or electronic circuits based on control signals from a pulse-width modulation (PWM) modulator 212 that control switching of switches 204.

PWM modulator 212 may generate control signals as a function of two parameters: a desired duty cycle D for controlling an inductor current I_{L} flowing through power inductor 208 and a balance factor α that defines a desired charge balance across flying capacitor 206 in order to regulate flying voltage V_{FLY}. Duty cycle D may be controlled by a feedback loop based on a measurement of inductor current I_{L}, while balance factor α may be controlled by a feedback loop based on a measurement of flying voltage V_{FLY}.

In the feedback loop for duty cycle D, a waveform correction block 230 may apply waveform correction to the measurement of inductor current I_{L}, as described in greater detail below. A feedback filter 214 may apply a filter response (e.g., a moving average filter) to the corrected measurement of inductor current I_{L}, and such filtered current may be subtracted from a setpoint target current I_{TGT} to generate an inductor error signal. The setpoint target current I_{TGT} may be a desired peak current, average current, or other suitable current setpoint for inductor current I_{L}. The inductor current error signal may be filtered by a loop filter 216 that applies a function to convert the inductor error signal into desired duty cycle D.

In some embodiments, information present in the control loop for regulating flying voltage V_{FLY} may be used to perform a correction in the control loop for regulating inductor current I_{L}. For example, as mentioned above, a waveform correction block 230 may apply waveform correction to the measurement of inductor current I_{L}. To illustrate, feedback filter 214 may minimize group delay in order to maximize bandwidth of the feedback loop for duty cycle D. The smallest duration for which feedback filter 214 may filter out any switching ripple may be one switching cycle of power inductor 208. However, 3-level power converter 202 may require two inductor switching cycles of power inductor 208 to complete its switching sequence. If flying voltage V_{FLY} is balanced across flying capacitor 206, power inductor 208 may achieve volt-second balance across one switching cycle of power inductor 208. On the other hand, if flying capacitor 206 is unbalanced, as potentially indicated by balance factor α being non-zero, power inductor 208 may require two switching cycles to achieve volt-second balance. Thus, in the absence of waveform correction block 230, feedback filter 214 may require a filter window of two switching cycles of power inductor 208, which may contribute significantly to the group delay of the feedback loop for duty cycle D. However, waveform correction block 230 may apply a correction term to the measurement of inductor current I_{L} as a function of balance factor α, thus ensuring a volt-second balance across one switching cycle of power inductor 208, and allowing for a one-cycle filtering (e.g., averaging) window for feedback filter 214.

In the feedback loop for balance factor α, a feedback filter 224 may apply a filter response (e.g., a moving average filter) to the measurement of flying voltage V_{FLY}, and such filtered voltage may be subtracted by half of input voltage V_{IN} to generate a flying voltage error signal. Such flying voltage error signal may be filtered by a loop filter 226 that applies a function to convert the flying voltage error signal into balance factor α.

In some embodiments, all or a portion of 3-level power converter feedback circuit 200 may be implemented on a single integrated circuit. For example, in some embodiments, PWM modulator 212, filter 216, filter 226, feedback filter 214, feedback filter 224 and waveform correction block 230 may be implemented on a single integrated circuit, while power converter 202 may be implemented on the integrated circuit or may be implemented external to the integrated circuit.

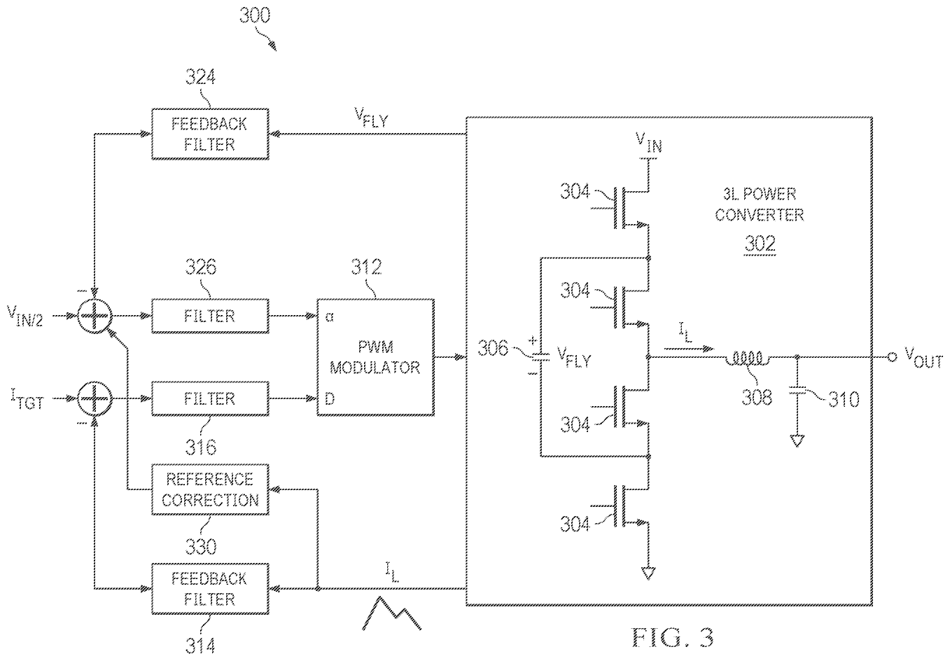

FIG. 3 illustrates a block diagram of selected components of another example architecture for 3-level power converter feedback circuit 300, in accordance with embodiments of the present disclosure. As shown in FIG. 3, 3-level power converter feedback circuit 300 may include a 3-level power converter 302 comprising a plurality of switches 304, a flying capacitor 306, a power inductor 308, and an output capacitor 310 arranged as depicted. In operation, 3-level power converter feedback circuit 300 may convert an input voltage V_{IN} (e.g., which may be provided by a battery or other source of electrical energy) into a regulated output voltage V_{OUT} which in turn may be used to supply electrical and/or electronic circuits based on control signals from a pulse-width modulation (PWM) modulator 312 that control switching of switches 304.

PWM modulator 312 may generate control signals as a function of two parameters: a desired duty cycle D for controlling an inductor current I_{L} flowing through power inductor 308 and a balance factor α that defines a desired charge balance across flying capacitor 306 in order to regulate flying voltage V_{FLY}. Duty cycle D may be controlled by a feedback loop based on a measurement of inductor current I_{L}, while balance factor α may be controlled by a feedback loop based on a measurement of flying voltage V_{FLY}.

In the feedback loop for duty cycle D, a feedback filter 314 may apply a filter response (e.g., a moving average filter) to the measurement of inductor current I_{L}, and such filtered current may be subtracted from a setpoint target current I_{TGT} to generate an inductor error signal. The setpoint target current I_{TGT} may be a desired peak current, average current, or other suitable current setpoint for inductor current I_{L}. The inductor current error signal may be filtered by a loop filter 316 that applies a function to convert the inductor error signal into desired duty cycle D.

Similarly, in the feedback loop for balance factor α, a feedback filter 324 may apply a filter response (e.g., a moving average filter) to the measurement of flying voltage V_{FLY}, and such filtered voltage may be subtracted by half of input voltage V_{IN} to generate a flying voltage error signal. Such flying voltage error signal may be filtered by a loop filter 326 that applies a function to convert the flying voltage error signal into balance factor α.

In some embodiments, information present in the control loop for regulating inductor current I_{L} flying voltage V_{FLY} may be used to perform a correction in the control loop for regulating flying voltage V_{FLY}. For example, as further shown in FIG. 3, a reference correction block 330 may apply a summative correction to the flying voltage error signal based on the measurement of inductor current I_{L}. To illustrate, even when balance factor α=0, flying capacitor 306 may still be slightly off balance. For example, such imbalance may due to an error in the reference voltage V_{IN}/2 input to the feedback loop for balance factor α, such as a difference between a measurement of input voltage V_{IN} used to generate the reference voltage V_{IN}/2 and the actual value of input voltage V_{IN}. In such a scenario, the measurement of inductor current I_{L} may include a tone at one-half of the switching frequency for power inductor 308. Accordingly, reference correction block 330 may apply a correction term to the flying voltage error signal as a function of the measurement of inductor current I_{L} in order to correct for such imbalance.

In some embodiments, all or a portion of 3-level power converter feedback circuit 300 may be implemented on a single integrated circuit. For example, in some embodiments, PWM modulator 312, filter 316, filter 326, feedback filter 314, feedback filter 324 and reference correction block 330 may be implemented on a single integrated circuit, while power converter 302 may be implemented on the integrated circuit or may be implemented external to the integrated circuit.

Although shown separately in FIGS. 2 and 3 for purposes of clarity and exposition, it is understood that in some embodiments of the present disclosure, a 3-level power converter feedback circuit may include both the features and functionality of both waveform correction block 230 and reference correction block 330.

The operations described above may be performed by a processor or any other circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general-purpose processor (e.g., CPU or DSP) capable of executing instructions contained in software. The firmware and/or software may include instructions that cause the processing of signals described herein to be performed. The circuitry or software may be organized as blocks that are configured to perform specific functions. Alternatively, some circuitry or software may be organized as shared blocks that can perform several of the described operations. In some embodiments, the IC that is the controller may include other functionality. For example, the controller IC may include an audio coder/decoder (CODEC) along with circuitry for performing the functions described herein. Such an IC is one example of an audio controller. Other audio functionality may be additionally or alternatively integrated with the IC circuitry described herein to form an audio controller.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks, and Blu-ray discs. Generally, disks reproduce data magnetically, and discs reproduce data optically. Combinations of the above should also be included within the scope of computer-readable media.

In addition to storage on computer readable media, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, where general purpose processors are described as implementing certain processing steps, the general purpose processor may be a digital signal processor (DSP), a graphics processing unit (GPU), a central processing unit (CPU), or other configurable logic circuitry. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A closed-loop feedback control system, comprising:
a first feedback control loop configured to regulate a first physical quantity;
a second feedback control loop orthogonal to the first feedback control loop and configured to regulate a second physical quantity; and
a correction block configured to apply a correction term to the first feedback control loop based on a parameter of the second feedback control loop.

2. The closed-loop feedback control system of claim 1, wherein the correction term is applied in a feedback path of the first control loop to a measurement of the first physical quantity.

3. The closed-loop feedback control system of claim 1, wherein the correction term is applied to an error signal representative of a difference between a measurement of the first physical quantity and a setpoint for the first physical quantity.

4. The closed-loop feedback control system of claim 1, wherein:
the first feedback control loop regulates a first amount of stored energy of a first energy storage element of a switched mode power supply; and
the second feedback control loop regulates a second amount of stored energy of a second energy storage element of the switched mode power supply.

5. The closed-loop feedback control system of claim 1, wherein:
the first physical quantity comprises an inductor current flowing through an inductor of a multi-level switched mode power supply; and
the second physical quantity comprises a voltage across a capacitor of the multi-level switched mode power supply.

6. The closed-loop feedback control system of claim 5, wherein the correction term is applied to a measurement of the inductor current in a feedback path of the first control loop based on a balance factor generated from an error signal of the second control loop.

7. The closed-loop feedback system of claim 6, wherein the error signal is indicative of a difference between the voltage and a reference voltage derived from an input voltage to the multi-level switched mode power supply.

8. The closed-loop feedback control system of claim 1, wherein:
the first physical quantity comprises a voltage across a capacitor of a multi-level switched mode power supply; and
the second physical quantity comprises an inductor current flowing through an inductor of the multi-level switched mode power supply.

9. The closed-loop feedback control system of claim 8, wherein the correction term is applied to an error signal of the first control loop and is based on a measurement of the inductor current.

10. The closed-loop feedback control system of claim 9, wherein the error signal is indicative of a difference between the voltage and a reference voltage derived from an input voltage to the multi-level switched mode power supply.

11. The closed-loop feedback control system of claim 1, further comprising a second correction block configured to apply a second correction term to the second feedback control loop based on a second parameter of the first feedback control loop.

12. A method comprising:
regulating a first physical quantity with a first feedback control loop;
regulating a second physical quantity with a second feedback control loop orthogonal to the first feedback control loop; and
applying a correction term to the first feedback control loop based on a parameter of the second feedback control loop.

13. The method of claim 12, further comprising applying the correction term in a feedback path of the first control loop to a measurement of the first physical quantity.

14. The method of claim 12, further comprising applying the correction term to an error signal representative of a difference between a measurement of the first physical quantity and a setpoint for the first physical quantity.

15. The method of claim 12, wherein:
the first feedback control loop regulates a first amount of stored energy of a first energy storage element of a switched mode power supply; and
the second feedback control loop regulates a second amount of stored energy of a second energy storage element of the switched mode power supply.

16. The method of claim 12, wherein:
the first physical quantity comprises an inductor current flowing through an inductor of a multi-level switched mode power supply; and
the second physical quantity comprises a voltage across a capacitor of the multi-level switched mode power supply.

17. The method of claim 16, further comprising applying the correction term to a measurement of the inductor current in a feedback path of the first control loop based on a balance factor generated from an error signal of the second control loop.

18. The method of claim 17, wherein the error signal is indicative of a difference between the voltage and a reference voltage derived from an input voltage to the multi-level switched mode power supply.

19. The method of claim 12, wherein:
the first physical quantity comprises a voltage across a capacitor of a multi-level switched mode power supply; and
the second physical quantity comprises an inductor current flowing through an inductor of the multi-level switched mode power supply.

20. The method of claim 19, further comprising applying the correction term to an error signal of the first control loop and is based on a measurement of the inductor current.

21. The method of claim 20, wherein the error signal is indicative of a difference between the voltage and a reference voltage derived from an input voltage to the multi-level switched mode power supply.

22. The method of claim 12, further applying a second correction term to the second feedback control loop based on a second parameter of the first feedback control loop.

23. An integrated circuit, comprising:
circuitry implementing a first feedback control loop configured to regulate a first physical quantity;
circuity implementing a second feedback control loop orthogonal to the first feedback control loop and configured to regulate a second physical quantity; and
circuitry implementing a correction block configured to apply a correction term to the first feedback control loop based on a parameter of the second feedback control loop.

24. The integrated circuit of claim 23, further comprising circuitry implementing a power converter, wherein the first physical quantity and the second physical quantity are physical quantities associated with operation of the power converter.

25. The integrated circuit of claim 23, wherein the first physical quantity and the second physical quantity are physical quantities associated with operation of a power converter external to the integrated circuit.
